(19) United States
(12) Patent Application Publication
(10) Pub. No.: US 2020/0082447 A1
(43) Pub. Date: Mar. 12, 2020

(54) SYSTEM AND METHODS FOR A COLLECTIVE SEARCH QUERY USING HIDDEN ATTRIBUTES

(71) Applicant: eBay Inc., San Jose, CA (US)

(72) Inventor: Vijay Jagdishprasad Dwivedi, Sunnyvale, CA (US)

(21) Appl. No.: 16/123,370

(22) Filed: Sep. 6, 2018

(51) Int. Cl. G06Q 30/06; G06Q 30/02

(52) U.S. Cl. CPC G06Q 30/0605; G06Q 30/0641; G06Q 30/0611; G06Q 30/0224

(57) ABSTRACT

A server detects that an application operating at a first client device of a first user is leaving a display of a listing provided by a publication application. The listing identifies an item and a corresponding a disclosed attribute value provided by a first provider of the item. The server queries the first client device for a desired attribute value in response to the detecting. The server receives the desired attribute value and a commitment to the desired attribute value from the first client device. The server accesses a database of hidden attribute values for the item and corresponding quantity range attribute values for the item listed with the first provider. The hidden attribute values and corresponding quantity range attribute values are provided by the first provider and hidden from the first client device. The server generates a fulfillment request to the first provider based on a number of commitments and corresponding desired attribute values from the first client device, the hidden attribute values and corresponding quantity range attribute values for the item from the first provider of the item.

### BACKGROUND

### Technical Field

The subject matter disclosed herein generally relates to a special-purpose machine that uses hidden attributes for a search query, including computerized variants of such special-purpose machines and improvements to such variants, and to the technologies by which such special-purpose machines become improved compared to other special-purpose machines that perform a search query based on displayed attributes. Specifically, the present disclosure addresses systems and methods that a collective search query using hidden attributes.

When searching for an item using a computing search engine operating on a server, users typically have a price range in mind for the item they wish to identify and purchase. The server identifies another user that is listing the item at a listing price. If the user performing the search wishes to communicate with the user listing the item to discuss the price point, such one-on-one process would be time consuming and cumbersome to both. For instance, the user listing the item may not be willing to reduce the listing price based on interest from a single buyer. However, the user listing the item may be willing to reduce to a price lower than the listing price only if there is enough interest from a sufficient number of users.

While a user listing an item may be willing to reduce the price if there is a sufficiently large number of buyers, the user listing the item may not want to disclose in advance the reduced price so as to reveal information to competitors. Further, the pricing reduction may vary depending on the number of buyers or the volume of the item purchased. Publishing a schedule of price-to-volume discount may be undesirable despite a seller's willingness to entertain such transactions, as the “fall-back” position may only need to be divulged if the seller is unable to attain the sale at a higher price point.

The ability to discern if a prospective buyer is willing to pay less than an initially listed price in a one-off transaction is straightforward—the seller need only ask the buyer. Similarly, the seller can offer a bulk-volume discount to a single buyer. But, if the realization of the bulk volume is attained only by multiple and disparate users, there currently is no feasible mechanism for soliciting such a group negotiation and transaction in an offline forum. And even in an online crowd-sourced bulk purchase, such a group negotiation isn't really negotiation at all but rather a “take-it or leave-it” proposition where a seller posts a price point available if a threshold number of purchases are met. Moreover, this existing approach requires the seller to “show” his/her cards by exposing the pricepoint/discount without dynamically gauging whether a prospective buyer would have purchased the item at a higher price-point.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a diagrammatic representation of a networked environment in which the present disclosure may be deployed, in accordance with some example embodiments.

FIG. 2 is a block diagram illustrating a marketplace application that, in one example embodiment, is provided as part of a networked system.

FIG. 3 is a block diagram illustrating a hidden attribute engine, in accordance with one example embodiment.

FIG. 4 is a flow diagram illustrating a method for incrementing a count based on a hidden attribute, in accordance with one example embodiment.

FIG. 5 is a flow diagram illustrating a method for incrementing a count based on a hidden attribute, in accordance with another example embodiment.

FIG. 6 is a flow diagram illustrating a method for incrementing a count based on a hidden attribute, in accordance with another example embodiment.

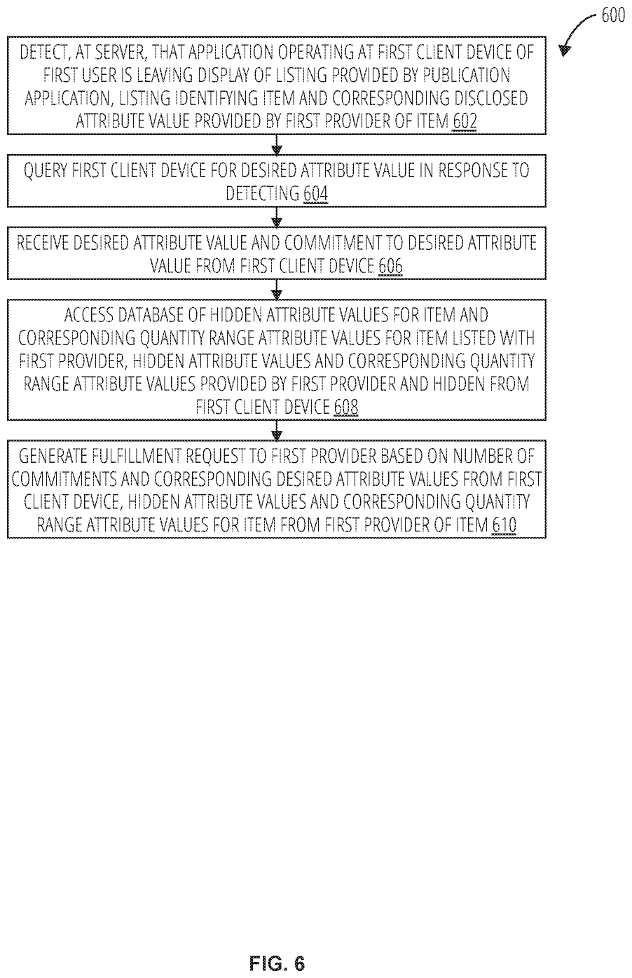

FIG. 7 illustrates a table of hidden attributes, in accordance with one example embodiment.

FIG. 8 is a block diagram illustrating an example operation of the hidden attribute engine, in accordance with one example embodiment.

FIG. 9 is a block diagram illustrating an example operation of the hidden attribute engine, in accordance with one example embodiment.

FIG. 10 is a block diagram illustrating an example operation of the hidden attribute engine, in accordance with another example embodiment.

FIG. 11 is a block diagram illustrating an example operation of the hidden attribute engine, in accordance with one example embodiment.

FIG. 12 is a block diagram illustrating an example of a display for a client device performing a search query, in accordance with one example embodiment.

FIG. 13 is a block diagram illustrating an example of a display for a client device listing an item, in accordance with one example embodiment.

FIG. 14 is a diagrammatic representation of a machine in the form of a computer system within which a set of instructions may be executed for causing the machine to perform any one or more of the methodologies discussed herein, according to an example embodiment.

### DETAILED DESCRIPTION

### Glossary

“Component” in this context refers to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various example embodiments, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application specific integrated circuit (ASIC). A hardware component may also include programmable logic or circuitry that is temporarily configured by software to perform certain operations. For example, a hardware component may include software executed by a general-purpose processor or other programmable processor. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some example embodiments, the processors or processor-implemented components may be located in a single geographic location (e.g., within a home environment, an office environment, or a server farm). In other example embodiments, the processors or processor-implemented components may be distributed across a number of geographic locations.

“Communication Network” in this context refers to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network and the coupling may be a Code Division Multiple Access (CDMA) connection, a Global System for Mobile communications (GSM) connection, or other types of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology.

“Machine-Storage Medium” in this context refers to a single or multiple storage devices and/or media (e.g., a centralized or distributed database, and/or associated caches and servers) that store executable instructions, routines and/or data. The term shall accordingly be taken to include, but not be limited to, solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Processor” in this context refers to any circuit or virtual circuit (a physical circuit emulated by logic executing on an actual processor) that manipulates data values according to control signals (e.g., “commands”, “op codes”, “machine code”, etc.) and which produces corresponding output signals that are applied to operate a machine. A processor may, for example, be a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC) or any combination thereof. A processor may further be a multi-core processor having two or more independent processors (sometimes referred to as “cores”) that may execute instructions contemporaneously.

“Carrier Signal” in this context refers to any intangible medium that is capable of storing, encoding, or carrying instructions for execution by the machine, and includes digital or analog communications signals or other intangible media to facilitate communication of such instructions. Instructions may be transmitted or received over a network using a transmission medium via a network interface device.

“Signal Medium” in this context refers to any intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

“Computer-Readable Medium” in this context refers to both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

### Description

The description that follows describes systems, methods, techniques, instruction sequences, and computing machine program products that illustrate example embodiments of the present subject matter. In the following description, for purposes of explanation, numerous specific details are set forth in order to provide an understanding of various embodiments of the present subject matter. It will be evident, however, to those skilled in the art, that embodiments of the present subject matter may be practiced without some or other of these specific details. Examples merely typify possible variations. Unless explicitly stated otherwise, structures (e.g., structural components, such as modules) are optional and may be combined or subdivided, and operations (e.g., in a procedure, algorithm, or other function) may vary in sequence or be combined or subdivided.

Buyers typically have a price range in mind for a product they wish to purchase (e.g., item x at $450). If they find a seller that is selling that product at the price point, a sale can be made. But if not, the buyer can make a price offer should the seller listing permit. This process is only between the buyer and seller and is time consuming and cumbersome to both. There would be a lot of back and forth messages that would eventually lead to either an agreement or a disagreement on a price point of the item.

A seller may not be willing to reduce his listing price based on interest from a single buyer. However, that seller may be willing to sell his items at a price lower than the listing price, only if he has interest from a sufficient number of buyers. This reduction in price may be referred to or known as bulk discount. However, current platforms do not have the ability to capture buying intent from a group of buyers along with their price bands or ranges and presenting it to one or more sellers for fulfillment. The present application provides a platform among interested parties (e.g., buyers and sellers) based on hidden attributes (e.g., bulk discounts that each seller is willing to give based on the number of buying intent from buyers). The bulk discount is hidden from display from the buyers. In other words, the sellers do not reveal the degree and extent of the bulk discount (e.g., the price curve of the discount based on quantity) to the buyers. Furthermore, each seller may have different discount price curve. The present application therefore describes an e-commerce platform where a buyer can offer a range of low and high price points for an item they are interested in and the e-commerce platform automatically fulfills the demand based on the hidden attributes from the sellers.

For example, when a buyer searches for a product and moves away from the page without clicking buy, the platform can show a pop-up display asking if the buyer is leaving because the price is too high. If so, the platform asks the buyer to provide a range of prices that the buyer willing to buy the product for. Similar information is captured from multiple buyers for the same product. For example, there are 20 buyers looking for item X and willing to pay between $460 and $480. The platform requests a commitment from the potential buyers (e.g., a $10 deposit from the buyers to make sure they are genuinely interested in the purchase at those price points). Depending on the quantity demanded by these potential buyers, this demand can be sent to one or more sellers for fulfillment: “Your item X is listed for $500. However, there are 20 buyers who are willing to offer $480. You can sell 20 units of item X with a single click at $480. Do you agree?” If the seller accepts, the buyers receive a confirmation that their desired price point was met and their item X is on the way.

In one example embodiment, a platform operating at a server, detects that an application operating at a first client device of a first user is leaving a display of a listing provided by a publication application (provided by the server). The listing identifies an item and a corresponding a disclosed attribute value provided by a first provider of the item. The server queries the first client device for a desired attribute value in response to the detection. The server receives the desired attribute value and a commitment to the desired attribute value from the first client device. The server accesses a database of hidden attribute values for the item and corresponding quantity range attribute values for the item listed with the first provider. The hidden attribute values and corresponding quantity range attribute values provided by the first provider and hidden from the first client device. The server generates a fulfillment request to the first provider based on a number of commitments and corresponding desired attribute values from the first client device, hidden attribute values and corresponding quantity range attribute values for the item from the first provider of the item.

As a result, one or more of the methodologies described herein facilitate solving the technical problem of enabling different client devices to communicate among themselves to agree on a common hidden attribute (e.g., bulk discount). The present platform enables building of the demand curve for an item where there is no differentiation between providers of the item. As such, one or more of the methodologies described herein may obviate a need for certain efforts or computing resources that otherwise would be involved in client devices leaving a listing for an item and continually performing search queries for other listings of the item without knowledge of hidden attributes. As a result, resources used by one or more machines, databases, or devices (e.g., within the environment) may be reduced. Examples of such computing resources include processor cycles, network traffic, memory usage, data storage capacity, power consumption, network bandwidth, and cooling capacity.

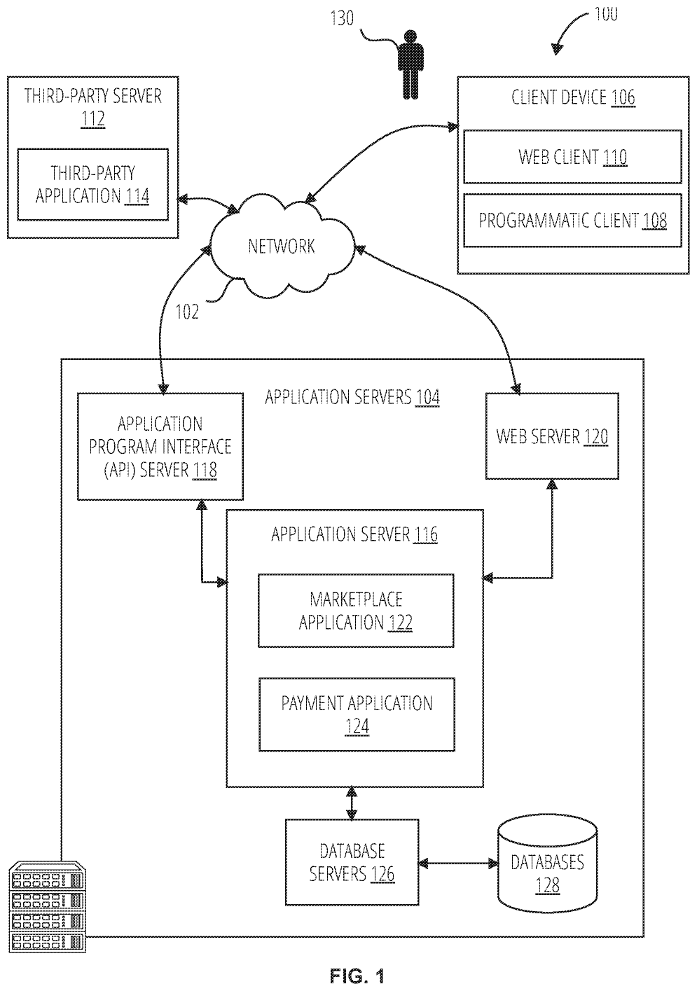

FIG. 1 is a diagrammatic representation of a network environment 100 in which some example embodiments of the present disclosure may be implemented or deployed. One or more application servers 104 provide server-side functionality via a network 102 to a networked user device, in the form of a client device 110. A web client 110 (e.g., a browser) and a programmatic client 108 (e.g., an “app”) are hosted and execute on the web client 110.

An Application Program Interface (API) server 118 and a web server 120 provide respective programmatic and web interfaces to application servers 104. A specific application server 116 hosts a marketplace application 122, which includes components, modules and/or applications.

The marketplace application 122 may provide a number of marketplace functions and services to users who access the application servers 104. The payment application 124 may likewise provide a number of payment services and functions to users. The payment application 124 may allow users to accumulate value (e.g., in a commercial currency, such as the U.S. dollar, or a proprietary currency, such as “points”) in accounts, and then later to redeem the accumulated value for products (e.g., goods or services) that are made available via the marketplace application 122. While the marketplace application 122 and the payment application 124 are shown in FIG. 1 to both form part of the application servers 104, it will be appreciated that, in alternative embodiments, the payment application 124 may form part of a payment service that is separate and distinct from the application server 116.

Further, while the network environment 100 shown in FIG. 1 employs a client-server architecture, the embodiments are, of course, not limited to such an architecture, and could equally well find application in a distributed, or peer-to-peer, architecture system, for example. The various marketplace application 122 and payment application 124 could also be implemented as standalone software programs, which do not necessarily have networking capabilities.

The web client 110 accesses the various marketplace application 122 and payment application 124 via the web interface supported by the web server 120. Similarly, the programmatic client 108 accesses the various services and functions provided by the marketplace application 122 and payment application 124 via the programmatic interface provided by the Application Program Interface (API) server 118. The programmatic client 108 may, for example, be a seller application (e.g., eBay Application developed by eBay Inc., of San Jose, Calif.) to enable sellers to author and manage listings on the network environment 100 in an offline manner, and to perform batch-mode communications between the programmatic client 108 and the application servers 104.

FIG. 1 also illustrates a third-party application 114 executing on a third-party server 112 as having programmatic access to the application servers 104 via the programmatic interface provided by the Application Program Interface (API) server 118. For example, the third-party application 114 may, utilizing information retrieved from the application server 116, support one or more features or functions on a website hosted by a third party. The third-party website may, for example, provide one or more promotional, marketplace, or payment functions that are supported by the relevant applications of the application servers 104.

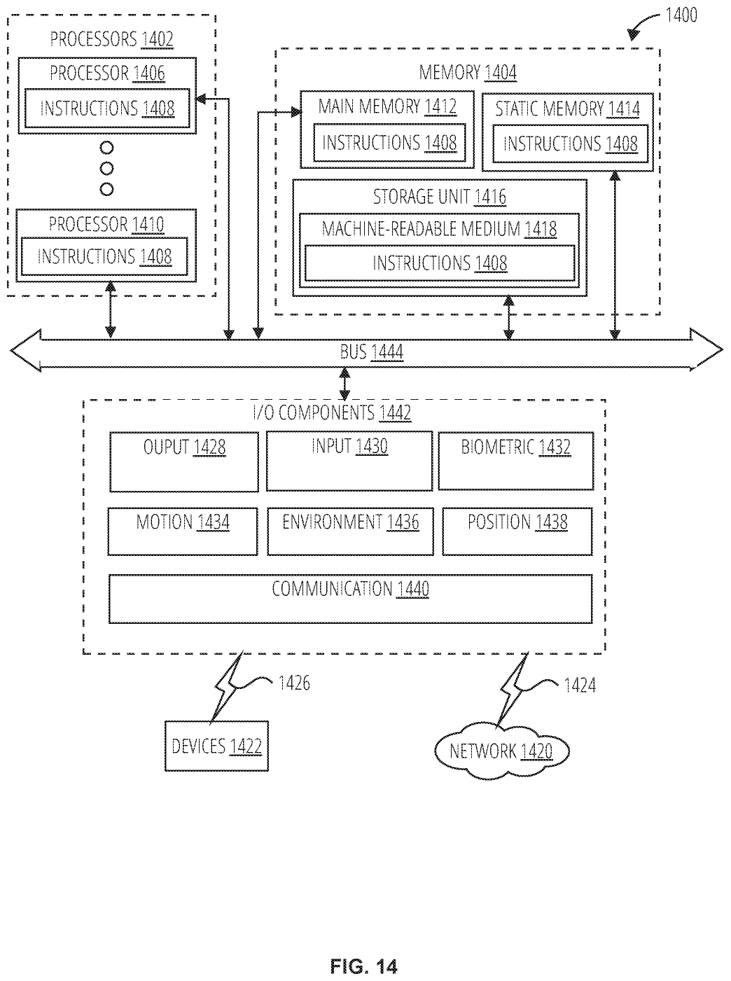

Any of the systems or machines (e.g., databases, devices, servers) shown in, or associated with, FIG. 1 may be, include, or otherwise be implemented in a special-purpose (e.g., specialized or otherwise non-generic) computer that has been modified (e.g., configured or programmed by software, such as one or more software modules of an application, operating system, firmware, middleware, or other program) to perform one or more of the functions described herein for that system or machine. For example, a special-purpose computer system able to implement any one or more of the methodologies described herein is discussed below with respect to FIG. 14, and such a special-purpose computer may accordingly be a means for performing any one or more of the methodologies discussed herein. Within the technical field of such special-purpose computers, a special-purpose computer that has been modified by the structures discussed herein to perform the functions discussed herein is technically improved compared to other special-purpose computers that lack the structures discussed herein or are otherwise unable to perform the functions discussed herein. Accordingly, a special-purpose machine configured according to the systems and methods discussed herein provides an improvement to the technology of similar special-purpose machines.

Moreover, any two or more of the systems or machines illustrated in FIG. 1 may be combined into a single system or machine, and the functions described herein for any single system or machine may be subdivided among multiple systems or machines. Additionally, any number and types of client device 106 may be embodied within the network environment 100. Furthermore, some components or functions of the network environment 100 may be combined or located elsewhere in the network environment 100. For example, some of the functions of the client device 106 may be embodied at the application server 116.

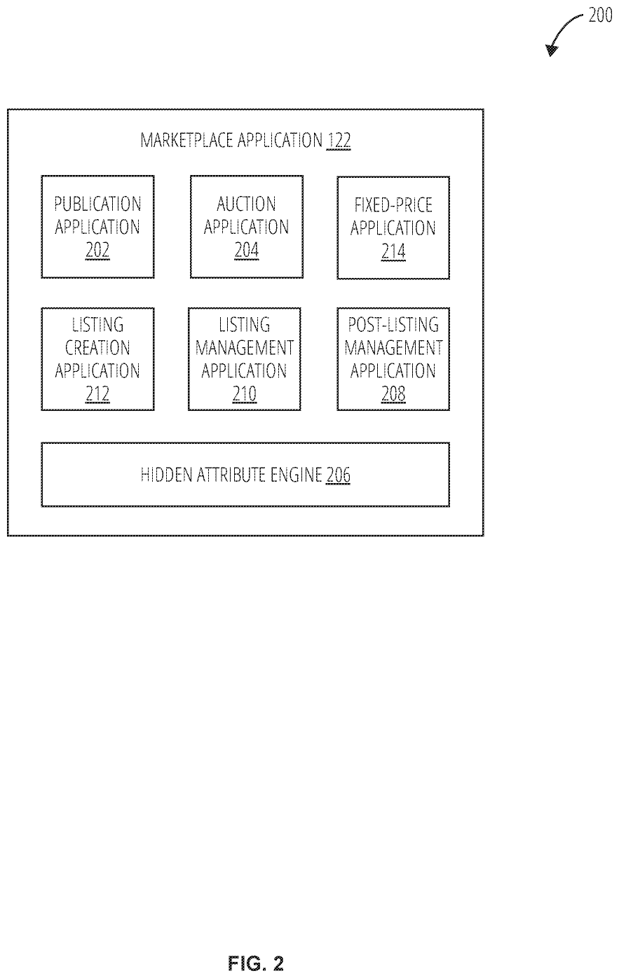

FIG. 2 is a block diagram illustrating the marketplace application 122 that, in one example embodiment, are provided as part of the network environment 100. The marketplace application 122 may be hosted on dedicated or shared server machines (not shown) that are communicatively coupled to enable communications between or among server machines. The marketplace application 122 themselves are communicatively coupled (e.g., via appropriate interfaces) to each other and to various data sources, so as to allow information to be passed between or among the marketplace application 122 or so as to allow the marketplace application 122 to share and access common data. The marketplace application 122 may furthermore access one or more databases 128 via the database servers 126.

The application server 116 may provide a number of publishing, listing, and price-setting mechanisms whereby a seller may list (or publish information concerning) goods or services for sale, a buyer can express interest in or indicate a desire to purchase such goods or services, and a price can be set for a transaction pertaining to the goods or services. To this end, the marketplace application 122 is shown to include at least one publication application 202 and one or more auction application 204, which support auction-format listing and price setting mechanisms (e.g., English, Dutch, Vickrey, Chinese, Double, Reverse auctions, etc.). The various auction application 204 may also provide a number of features in support of such auction-format listings, such as a reserve price feature whereby a seller may specify a reserve price in connection with a listing and a proxy-bidding feature whereby a bidder may invoke automated proxy bidding.

A number of fixed-price application 214 support fixed-price listing formats (e.g., the traditional classified advertisement-type listing or a catalogue listing) and buyout-type listings. Specifically, buyout-type listings (e.g., including the Buy-It-Now (BIN) technology developed by eBay Inc., of San Jose, Calif.) may be offered in conjunction with auction-format listings and allow a buyer to purchase goods or services, which are also being offered for sale via an auction, for a fixed price that is typically higher than the starting price of the auction.

Listing creation application 212 allow sellers to conveniently author listings pertaining to goods or services that they wish to transact via the application servers 104, and listing management application 210 allow sellers to manage such listings. Specifically, where a particular seller has authored and/or published a large number of listings, the management of such listings may present a challenge. The listing management application 210 provides a number of features (e.g., auto-relisting, inventory level monitors, etc.) to assist the seller in managing such listings. The post-listing management application 208 also assists sellers with a number of activities that typically occur post-listing.

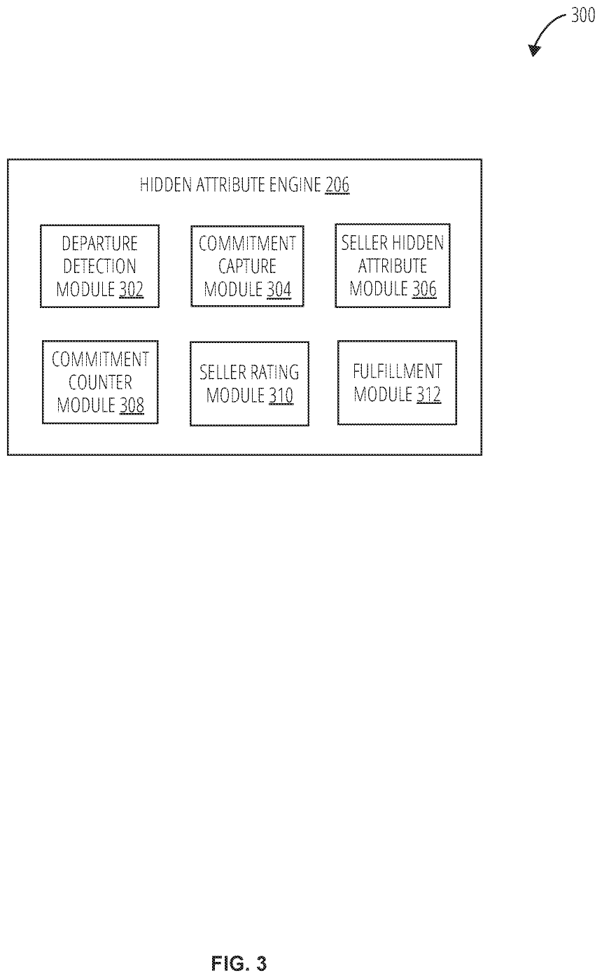

A hidden attribute engine 206 enables a user (e.g., a seller) to provide hidden attribute values (e.g., price points or discounted price and corresponding quantity ranges) for an item listed by the user using the listing creation application 212. The hidden attribute engine 206 provides a “second chance” to a potential buyer that is visiting a page that includes the listing with a public price point. The hidden attribute engine 206 captures an intent of the buyer to commit to a lower price (lower than the public price point) for the item. The hidden attribute engine 206 aggregates the number of intents or commitments from the buyers for the item and generates a fulfillment request to one or more identified sellers of the item based on their corresponding hidden attributes (e.g., private price points and corresponding quantity attributes). The hidden attribute engine 206 is described in more detail below with respect to FIG. 3.

It should be noted that the term “web browser” as used in this disclosure shall be interpreted broadly to cover any application capable of displaying item attributes and rendering images from a web server. As such, this may include traditional web browsers as well as stand-alone applications (or apps) operating on mobile or other devices. For example, the web browser could be a traditional web browser such as Internet Explorer from Microsoft Corp., a stand-alone app such as a shopping application, a video player app, etc.

In another example where the web browser is a stand-alone app, it may be operating on, for example, a mobile device having a display and a camera. The techniques described herein could therefore be applied to an image obtained by the mobile device from an outside source, such as via the Internet, an image previously stored on the mobile device, or an image taken by the camera on the mobile device, potentially in real time. Indeed, the techniques described herein can be applied on any device that is capable of obtaining a digital image and transmitting portions of that digital image to another device. Mobile devices are certainly one example, but others are possible as well, such as wearables and head-mounted devices.

FIG. 3 is a block diagram illustrating a hidden attribute engine, in accordance with one example embodiment. The hidden attribute engine 206 enables buyers and sellers to commit to a private price point for an item based on the price point ranges from the buyers and the hidden discounted price and corresponding quantities from the sellers. In one example embodiment, the hidden attribute engine 206 comprises a departure detection module 302, a commitment capture module 304, a seller hidden attribute module 306, a commitment counter module 308, a seller rating module 310, and a fulfillment module 312. The departure detection module 302 detects whether user 130 (e.g., a buyer) is leaving a page listing of an item. For example, the departure detection module 302 detects that the user 130 is browsing listing pages provided by the marketplace application 122 and has settled on a particular page listing an item for more than the average time on the other pages (e.g., 10 seconds instead of average of 2 seconds per page/item listing). The departure detection module 302 then detects that the user 130 is leaving the page listing without purchasing the item after 10 seconds. The departure detection module 302 then generates a message (e.g., a pop up window) to the client device 106. The departure detection module 302 generates a message queries whether the user 130 would like to provide a desired price (lower than publicly displayed price from the listing) for the item. In one example, the desired price includes a price point (e.g., $380) or a range of price points (e.g., $300 to $350).

The commitment capture module 304 captures a commitment from the user 130. One example of a commitment includes a monetary deposit using, for example, the payment application 124. The monetary deposit may be a flat amount (e.g., $10) irrespective of the listing price of the item, or an amount based on the listing price of the item (e.g., $25% of the listing price). In another example embodiment, the commitment may include a written agreement for the user 130 to commit to purchase the item at the desired lower price.

The seller hidden attribute module 306 collects hidden attributes values from the seller of the item. For example, the seller hidden attribute module 306 queries the seller for the public listing price (e.g., $400), hidden price (e.g., $380), and corresponding quantity ranges (e.g., 5 to 20 units) for the item. The hidden price and quantity ranges are undisclosed to the buyers. The buyers can only see the public price listed by the seller. In one example embodiment, the hidden price is not disclosed to the buyers until the prerequisite volume is met. In another example, a range of the quantities of ordered units from the user 130 and other buyers is disclosed to the buyer after the prerequisite volume is met (e.g., “your desired price of $380 has been accepted since more than 15 units are being sold at $380 in the same transaction”).

The commitment counter module 308 generates a counter that counts the number of units being committed by potential buyers. For example, every time a buyer is committing to purchasing 1 unit of item X, the counter for the item X increases by 1. In one example embodiment, the commitment counter module 308 operates within a predefined period of time (e.g., 24 hours) after receiving a desired price point from the user 130. The commitment counter module 308 increments the counter on the seller side to determine if an acceptable quantity to the seller at the hidden price point has been met. In another example embodiment, the commitment counter module 308 logs, along with the total counts, the count and the corresponding desired price point from the buyers (e.g., total counts 8 units: 5 units at $380, 3 units at $370). The seller rating module 310 tracks the rating of a seller. The rating may be based on feedback from buyers. The fulfillment module 312 generates a fulfillment query to the seller(s) based on the hidden attributes, the number of commitments, and the desired price points. For example, 200 units of item X are being ordered at a desired price point. The fulfillment module 312 generates a fulfillment request to seller A to fulfill 150 units and seller B to fulfill 50 units. In one example embodiment, seller A and B may be selected based on their corresponding ratings provided by seller rating module 310.

In another example, the fulfillment module 312 notifies the buyers that they collectively are short in the number of units to qualify for a bulk discount: “Your desired price of $380 is almost accepted; only 5 more orders are needed to qualify for a bulk purchase at $380. Do you want to increase your purchase quantity or raise your desired price?”

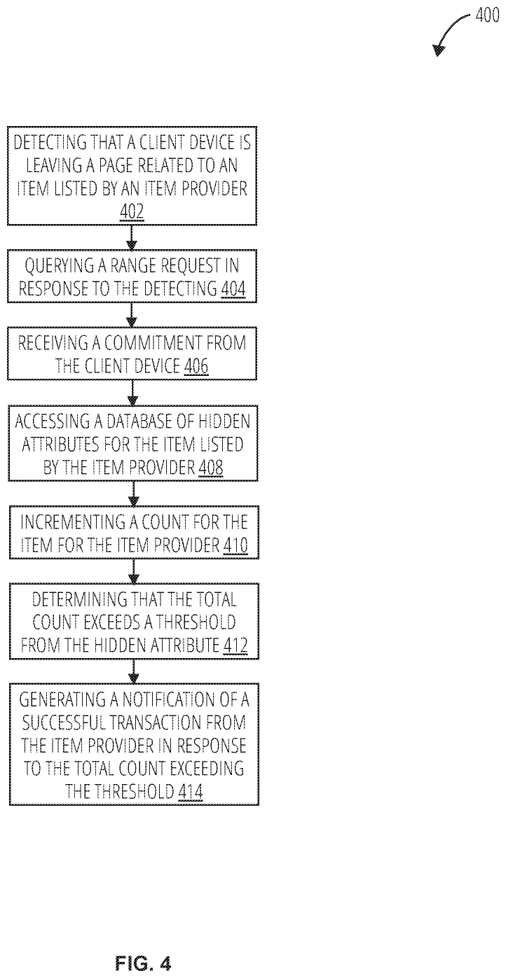

FIG. 4 is a flow diagram illustrating a method 400 for incrementing a count for an item, in accordance with an example embodiment. Operations in the method 400 may be performed by the hidden attribute engine 206, using components (e.g., modules, engines) described above with respect to FIG. 3. Accordingly, the method 400 is described by way of example with reference to the hidden attribute engine 206. However, it shall be appreciated that at least some of the operations of the method 400 may be deployed on various other hardware configurations or be performed by similar components residing elsewhere. For example, some of the operations may be performed at the client device 106.

In block 402, the departure detection module 302 detects that client device 106 is leaving a page displaying a listing of an item listed by an item provider. In block 404, the commitment capture module 304 queries the client device 106 for a desired range (e.g., $360-$380) or a desired price point ($380). At block 406, the commitment capture module 304 receives a commitment from the client device 106. At block 408, the seller hidden attribute module 306 accesses a database at databases 128 for hidden attributes for the item listed by the item provider. At block 410, the commitment counter module 308 increments a count for the item for the item provider in response to receiving the commitment. At block 412, the fulfillment module 312 determines that the total count exceeds a threshold from the hidden attribute. At block 414, the fulfillment module 312 generates a notification of a successful transaction from the item provider in response to determining that the total count exceeds the threshold.

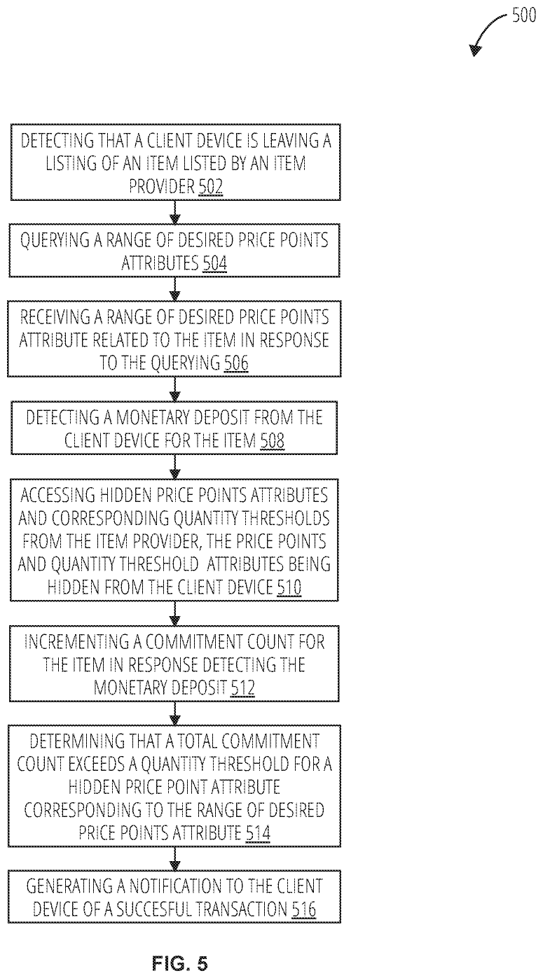

FIG. 5 is a flow diagram illustrating a method 500 for incrementing a count for an item, in accordance with another example embodiment. Operations in the method 500 may be performed by the hidden attribute engine 206, using components (e.g., modules, engines) described above with respect to FIG. 3. Accordingly, the method 500 is described by way of example with reference to the hidden attribute engine 206. However, it shall be appreciated that at least some of the operations of the method 500 may be deployed on various other hardware configurations or be performed by similar components residing elsewhere. For example, some of the operations may be performed at the client device 106.

In block 502, the departure detection module 302 detects that the client device 106 is leaving a page listing of an item listed by an item provider. The departure detection module 302 queries a range of desired price point attributes. At block 506, the departure detection module 302 receives a range of desired price point attributes from the client device 106. At block 508, the commitment capture module 304 communicates with the payment application 124 and detects a monetary deposit from the client device 106 for the item.

In block 510, the seller hidden attribute module 306 accesses the hidden price points attributes and corresponding quantity thresholds from the item provider for the item. The price points and quantity thresholds are hidden from the client device 106 (not disclosed to the client device 106). At block 512, the commitment counter module 308 increments a commitment count for the item (irrespective of the seller) in response to detecting the monetary deposit. At block 514, the fulfillment module 312 determines that a total commitment count exceeds a quantity threshold for a hidden price point attribute corresponding to a range of desired price point attribute. At block 516, the fulfillment module 312 generates a notification to the client device 106 (and other client devices with successful transactions) of the successful transaction.

In block 602, routine 600 detects, at a server, that an application operating at a first client device of a first user is leaving a display of a listing provided by a publication application, the listing identifying an item and a corresponding a disclosed attribute value provided by a first provider of the item. In block 604, routine 600 queries the first client device for a desired attribute value in response to the detecting. In block 606, routine 600 receives the desired attribute value and a commitment to the desired attribute value from the first client device. In block 608, routine 600 accesses a database of hidden attribute values for the item and corresponding quantity range attribute values for the item listed with the first provider, the hidden attribute values and corresponding quantity range attribute values provided by the first provider and hidden from the first client device. In block 610, routine 600 generates a fulfillment request to the first provider based on a number of commitments and corresponding desired attribute values from the first client device, hidden attribute values and corresponding quantity range attribute values for the item from the first provider of the item.

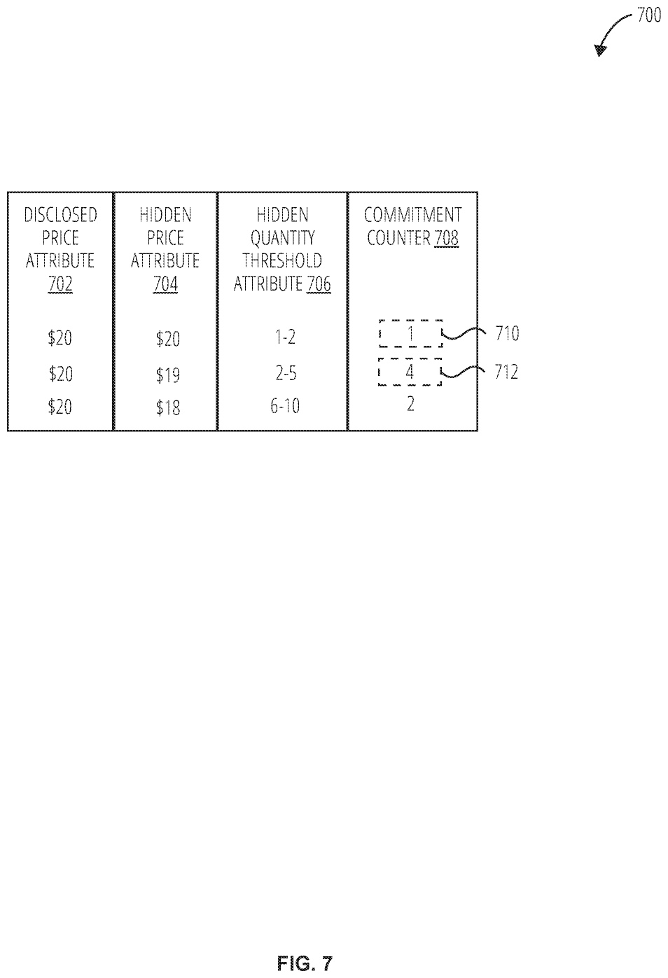

FIG. 7 illustrates a table of hidden attributes, in accordance with one example embodiment. The table 700 includes disclosed price attribute 702, hidden price attribute 704, hidden quantity threshold attribute 706, and commitment counter 708. The disclosed price attribute 702 represents the public listing price (e.g., $20) for the item by a seller (also referred to as item provider). The hidden price attribute 704 represents the discounted price/bulk price (hidden from the buyer) at which the seller is willing to sell (e.g., $20, $19, $18). The hidden quantity threshold attribute 706 represents the threshold quantity or ranges for the corresponding discounted price (e.g., 2 to 5 units minimum to obtain a discounted price of $19). The commitment counter 708 increments a counter for the respective hidden price attribute 704. For example, the box 710 indicates that one buyer has committed to purchasing the item at $20. The box 712 indicates that 4 buyers (or another buyer with an order of 4 units of the item) have committed to purchasing the same item at $19.

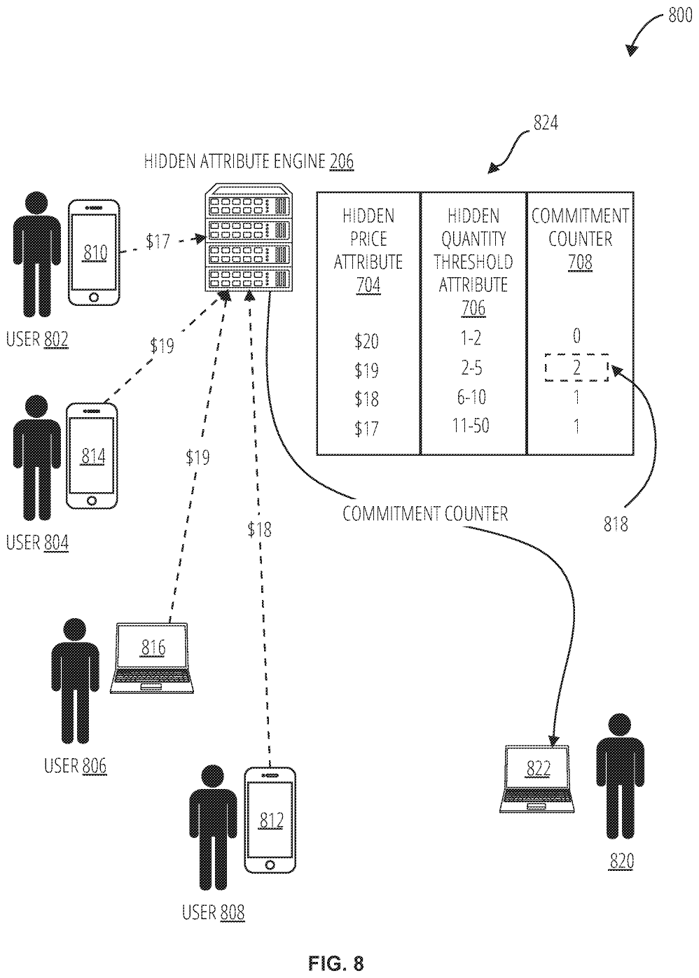

FIG. 8 is a block diagram illustrating an example operation of the hidden attribute engine, in accordance with one example embodiment. A user 802 of a client device 810 submits a desired price attribute of $17 for item X to the hidden attribute engine 206. A user 804 of a client device 814 submits a desired price attribute of $19 for the same item X to the hidden attribute engine 206. A user 806 of a client device 816 submits a desired price attribute of $19 for the same item X to the hidden attribute engine 206. A user 808 of a client device 812 submits a desired price attribute of $18 for the same item X to the hidden attribute engine 206. The hidden attribute engine 206 generates a table 824. In one example, table 824 includes the hidden price attribute 704, the hidden quantity threshold attribute 706, and the commitment counter 708. Box 818 indicates that there are 2 units being committed to by the users for a price point of $19. Box 818 further indicates that the number of units being committed to fall within the corresponding range of hidden quantity threshold (e.g., 2-5 units) for the corresponding hidden price attribute of $19. The example of FIG. 8 illustrates the table 824 being based on hidden price attribute 704 and corresponding hidden quantity threshold attribute 706 provided by client device 822 of the user 820 (e.g., seller of the item X). The hidden attribute engine 206 determines that the number of units being committed falls within the corresponding range of hidden quantity threshold (e.g., 2-5 units) for the corresponding hidden price attribute of $19. The hidden attribute engine 206 generates a notification to the client device 822. The notification identifies the number of commitments based on the commitment counter 708.

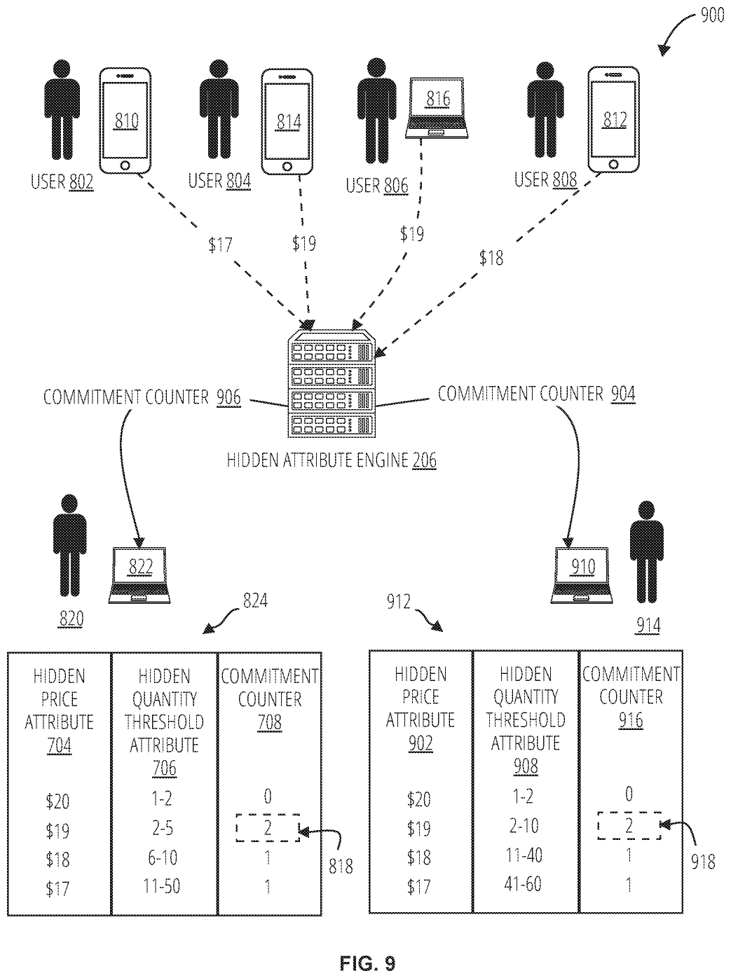

FIG. 9 is a block diagram illustrating an example operation of the hidden attribute engine, in accordance with one example embodiment. The user 802 of the client device 810 submits a desired price attribute of $17 for item X to the hidden attribute engine 206. The user 804 of the client device 814 submits a desired price attribute of $19 for the same item X to the hidden attribute engine 206. The user 806 of the client device 816 submits a desired price attribute of $19 for the same item X to the hidden attribute engine 206. The user 808 of the client device 812 submits a desired price attribute of $18 for the same item X to the hidden attribute engine 206. Both the user 820 and user 914 have used the marketplace application 122 to list the same item X. The hidden attribute engine 206 generates the table 824 for the user 820 of the client device 822 and a table 912 for the user 914 of the client device 910.

In the present example of FIG. 9, table 912 includes the hidden price attribute 902, the hidden quantity threshold attribute 908, and the commitment counter 916. It is noted that the item providers (e.g., user 820, user 914) each have different hidden quantity threshold ranges. For example, user 914 indicated a higher range (e.g., 11-40 units) for a discounted price of $18 for the item X while user 820 indicated a lower range (e.g., 2-5 units) for the same discounted price of $18 for the same item X. A commitment counter is provided for each user. For example, the hidden attribute engine 206 provides commitment counter 906 to the client device 822 of the user 820. The hidden attribute engine 206 provides commitment counter 904 to the client device 910 of the user 914. The box 918 indicates that the number of units being committed falls within the corresponding range of hidden quantity threshold (e.g., 2-10 units) for the corresponding hidden price attribute of $19.

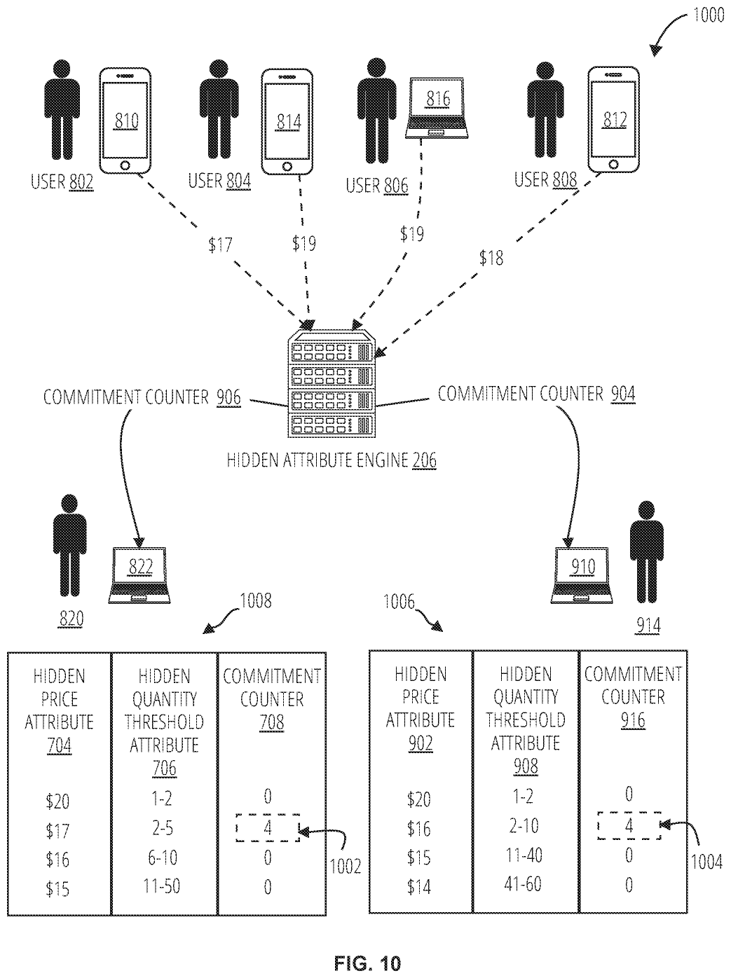

FIG. 10 is a block diagram illustrating an example operation of the hidden attribute engine, in accordance with another example embodiment. The user 802 of the client device 810 submits a desired price attribute of $17 for item X to the hidden attribute engine 206. The user 804 of the client device 814 submits a desired price attribute of $19 for the same item X to the hidden attribute engine 206. The user 806 of the client device 816 submits a desired price attribute of $19 for the same item X to the hidden attribute engine 206. The user 808 of the client device 812 submits a desired price attribute of $18 for the same item X to the hidden attribute engine 206. Both the user 820 and user 914 have used the marketplace application 122 to list the same item X for a common public listed price of $20. The hidden attribute engine 206 generates the table 1008 for the user 820 of the client device 822 and a table 1006 for the user 914 of the client device 910.

In the present example of FIG. 10, table 1008 includes the hidden price attribute 704, the hidden quantity threshold attribute 706, and the commitment counter 708. The table 1006 includes the hidden price attribute 902, the hidden quantity threshold attribute 908, and the commitment counter 916. It is noted that the item providers (e.g., user 820, user 914) each have different hidden quantity threshold ranges that overlap. For example, user 914 indicated a lower price of $16 for a range of 2 to 10 units while user 820 indicated a higher price of $17 for a range of 2 to 5 units for the same item X. A commitment counter is provided for each user. For example, the hidden attribute engine 206 provides commitment counter 906 to the client device 822 of the user 820. The hidden attribute engine 206 provides commitment counter 904 to the client device 910 of the user 914.

The box 1002 indicates that the number of units being committed falls within the corresponding range of hidden quantity threshold (e.g., 2-5 units) for the corresponding hidden price attribute of $17. In other words, the user 820 is willing to sell the item X to user 802, user 804, user 806, and user 808 for $17 because the number of commitments falls within the 2-5 hidden quantity threshold range and each of the desired price attributes ($17, $19, $19, $18) is greater than the hidden price attribute ($17) corresponding to the 2-5 hidden quantity threshold range.

The box 1004 indicates that the number of units being committed falls within the corresponding range of hidden quantity threshold (e.g., 2-10 units) for the corresponding hidden price attribute of $16. In other words, the user 914 is willing to sell the item X to user 802, user 804, user 806, and user 808 for $16 because the number of commitments falls within the 2-5 hidden quantity threshold range and each of the desired price attributes ($17, $19, $19, $18) is greater than the hidden price attribute ($16) corresponding to the 2-10 hidden quantity threshold range.

The hidden attribute engine 206 determines that both user 820 and user 914 can fulfill the transaction. based on the volume and desired prices. For example, the hidden attribute engine 206 generates a fulfillment request to either user 820 or user 914. In another example embodiment, the hidden attribute engine 206 includes a learning algorithm (not shown) that selects which user to send the fulfillment request and change a price attribute in the fulfillment request.

For example (example 1), the hidden attribute engine 206 selects the lowest price attribute (to satisfy the buyers) between the matching price attribute (e.g., box 1002 and box 1004: $16 from user 914 instead of $17 from user 820) and charges each user (user 802, user 804, user 806, user 808) $16 for a total amount of $48.

In another example (example 2), the hidden attribute engine 206 selects the highest price attribute (to satisfy one of the sellers) between the matching price attribute (e.g., box 1002 and box 1004: $17 from user 820 instead of $16 from user 914) and charges each user (user 802, user 804, user 806, user 808) $17 for a total amount of $54.

In yet another example (example 3), the hidden attribute engine 206 selects the highest price attribute between box 1002 and box 1004 ($17) to charge the buyers (e.g., user 802, user 804, user 806, user 808) and selects the lowest price attribute between box 1002 and box 1004 ($16) to inform one of the seller (e.g., user 914).

The learning algorithm can choose different paths (e.g., between example 1, 2, and 3) at different points in time. The hidden attribute engine 206 can implement the learning algorithm with Machine Learning to solve the settlement price by predicting which goal of the marketplace application 122 is to be most maximized (e.g., buyer satisfaction, seller satisfaction, growth in number of sales, revenue growth). For example, if the marketplace application 122 emphasizes buyer satisfaction, the learning algorithm will guide the hidden attribute engine 206 to follow the path of example 1. If the marketplace application 122 emphasizes seller satisfaction, the learning algorithm will guide the hidden attribute engine 206 to follow the path of example 2. If the marketplace application 122 emphasizes revenue growth, the learning algorithm will guide the hidden attribute engine 206 to follow the path of example 3.

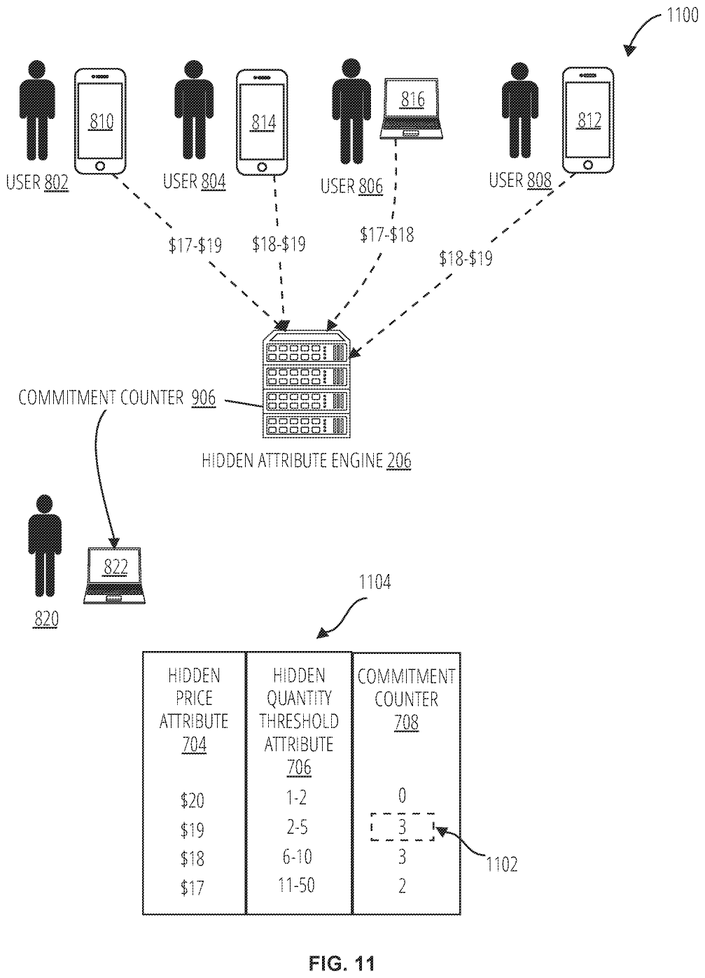

FIG. 11 is a block diagram illustrating an example operation of the hidden attribute engine, in accordance with one example embodiment. The user 802 of the client device 810 submits a desired price range attribute of $17-$19 for item X to the hidden attribute engine 206. The user 804 of the client device 814 submits a desired price range attribute of $18-$19 for the same item X to the hidden attribute engine 206. A user 806 of a client device 816 submits a desired price range attribute of $17-$18 for the same item X to the hidden attribute engine 206. A user 808 of a client device 812 submits a desired price range attribute of $18-$19 for the same item X to the hidden attribute engine 206. The hidden attribute engine 206 generates a table 1104. In one example, table 1104 includes the hidden price attribute 704, the hidden quantity threshold attribute 706, and the commitment counter 708. The hidden attribute engine 206 increments the commitment counter 708 for each corresponding price point within the desired price range attribute for each user. For example, the desired price range of $17-$19 from the user 802 counts as 1 count for the hidden price attribute $17, 1 count for the hidden price attribute $18, and 1 count for the hidden price attribute $19. Box 1102 indicates that there are 3 units being committed to by the users (e.g., user 802, user 804, user 808) for a price point of $19. The hidden attribute engine 206 generates a notification to the client device 822. The notification identifies the number of commitments based on the commitment counter 708.

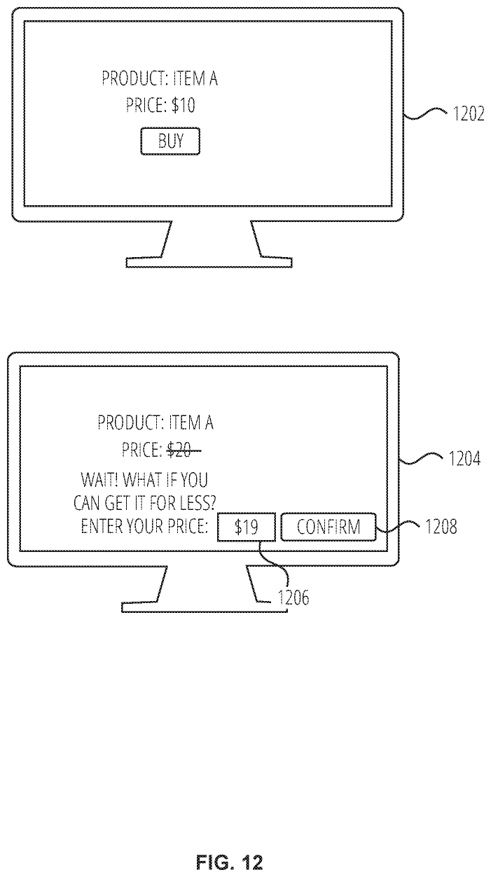

FIG. 12 is a block diagram illustrating an example operation of the hidden attribute engine, in accordance with one example embodiment. An example of a screenshot 1202 identifies the product item and the corresponding listed price (e.g., $10) at the client device 106. Another example of a screenshot 1204 is displayed in response to detecting a departure from a listing page such as the screenshot 1202. The screenshot 1204 requests the user 130 to enter a desired price point 1206 and to confirm with confirmation button 1208.

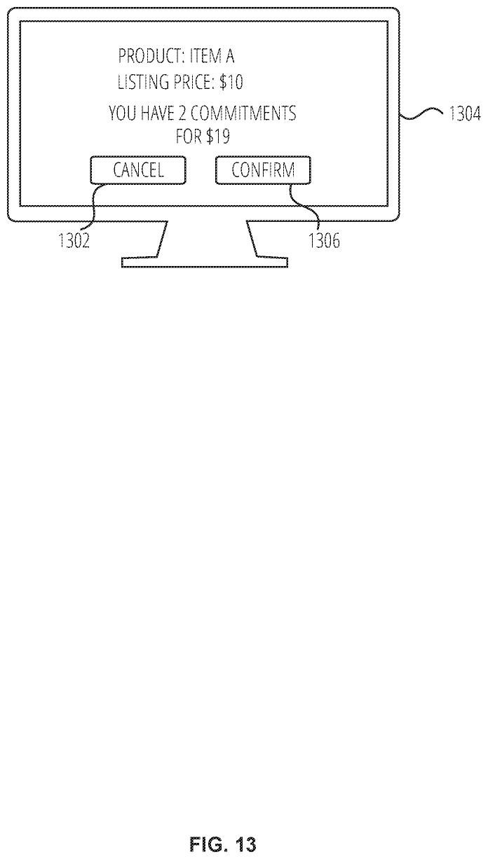

FIG. 13 is a block diagram illustrating an example operation of the hidden attribute engine, in accordance with one example embodiment. An example of a screenshot 1304 identifies the number of commitments from potential buyers at the client device of the sellers of the item. The screenshot 1304 also displays a confirmation request from the seller using confirmation button 1306 or a cancellation request using cancellation button 1302.

FIG. 14 is a diagrammatic representation of the machine 1400 within which instructions 1408 (e.g., software, a program, an application, an applet, an app, or other executable code) for causing the machine 1400 to perform any one or more of the methodologies discussed herein may be executed. For example, the instructions 1408 may cause the machine 1400 to execute any one or more of the methods described herein. The instructions 1408 transform the general, non-programmed machine 1400 into a particular machine 1400 programmed to carry out the described and illustrated functions in the manner described. The machine 1400 may operate as a standalone device or may be coupled (e.g., networked) to other machines. In a networked deployment, the machine 1400 may operate in the capacity of a server machine or a client machine in a server-client network environment, or as a peer machine in a peer-to-peer (or distributed) network environment. The machine 1400 may comprise, but not be limited to, a server computer, a client computer, a personal computer (PC), a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1408, sequentially or otherwise, that specify actions to be taken by the machine 1400. Further, while only a single machine 1400 is illustrated, the term “machine” shall also be taken to include a collection of machines that individually or jointly execute the instructions 1408 to perform any one or more of the methodologies discussed herein.

The machine 1400 may include processors 1402, memory 1404, and I/O components 1442, which may be configured to communicate with each other via a bus 1444. In an example embodiment, the processors 1402 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 1406 and a processor 1410 that execute the instructions 1408. The term “processor” is intended to include multi-core processors that may comprise two or more independent processors (sometimes referred to as “cores”) that may execute instructions contemporaneously. Although FIG. 14 shows multiple processors 1402, the machine 1400 may include a single processor with a single core, a single processor with multiple cores (e.g., a multi-core processor), multiple processors with a single core, multiple processors with multiples cores, or any combination thereof.

The memory 1404 includes a main memory 1412, a static memory 1414, and a storage unit 1416, both accessible to the processors 1402 via the bus 1444. The main memory 1404, the static memory 1414, and storage unit 1416 store the instructions 1408 embodying any one or more of the methodologies or functions described herein. The instructions 1408 may also reside, completely or partially, within the main memory 1412, within the static memory 1414, within machine-readable medium 1418 within the storage unit 1416, within at least one of the processors 1402 (e.g., within the processor's cache memory), or any suitable combination thereof, during execution thereof by the machine 1400.

The I/O components 1442 may include a wide variety of components to receive input, provide output, produce output, transmit information, exchange information, capture measurements, and so on. The specific I/O components 1442 that are included in a particular machine will depend on the type of machine. For example, portable machines such as mobile phones may include a touch input device or other such input mechanisms, while a headless server machine will likely not include such a touch input device. It will be appreciated that the I/O components 1442 may include many other components that are not shown in FIG. 14. In various example embodiments, the I/O components 1442 may include output components 1428 and input components 1430. The output components 1428 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1430 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 1442 may include biometric components 1432, motion components 1434, environmental components 1436, or position components 1438, among a wide array of other components. For example, the biometric components 1432 include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 1434 include acceleration sensor components (e.g., accelerometer), gravitation sensor components, rotation sensor components (e.g., gyroscope), and so forth. The environmental components 1436 include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 1438 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1442 further include communication components 1440 operable to couple the machine 1400 to a network 1420 or devices 1422 via a coupling 1424 and a coupling 1426, respectively. For example, the communication components 1440 may include a network interface component or another suitable device to interface with the network 1420. In further examples, the communication components 1440 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1422 may be another machine or any of a wide variety of peripheral devices (e.g., a peripheral device coupled via a USB).

Moreover, the communication components 1440 may detect identifiers or include components operable to detect identifiers. For example, the communication components 1440 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1440, such as location via Internet Protocol (IP) geolocation, location via Wi-Fi® signal triangulation, location via detecting an NFC beacon signal that may indicate a particular location, and so forth.

The various memories (e.g., memory 1404, main memory 1412, static memory 1414, and/or memory of the processors 1402) and/or storage unit 1416 may store one or more sets of instructions and data structures (e.g., software) embodying or used by any one or more of the methodologies or functions described herein. These instructions (e.g., the instructions 1408), when executed by processors 1402, cause various operations to implement the disclosed embodiments.

The instructions 1408 may be transmitted or received over the network 1420, using a transmission medium, via a network interface device (e.g., a network interface component included in the communication components 1440) and using any one of a number of well-known transfer protocols (e.g., hypertext transfer protocol (HTTP)). Similarly, the instructions 1408 may be transmitted or received using a transmission medium via the coupling 1426 (e.g., a peer-to-peer coupling) to the devices 1422.

Although an embodiment has been described with reference to specific example embodiments, it will be evident that various modifications and changes may be made to these embodiments without departing from the broader scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

### EXAMPLES

Example 1 is a computer-implemented method. The method comprises: detecting, at a server, that an application operating at a first client device of a first user is leaving a display of a listing provided by a publication application, the listing identifying an item and a corresponding a disclosed attribute value provided by a first provider of the item; querying the first client device for a desired attribute value in response to the detecting; receiving the desired attribute value and a commitment to the desired attribute value from the first client device; accessing a database of hidden attribute values for the item and corresponding quantity range attribute values for the item listed with the first provider, the hidden attribute values and corresponding quantity range attribute values provided by the first provider and hidden from the first client device; and generating a fulfillment request to the first provider based on a number of commitments and corresponding desired attribute values from the first client device, hidden attribute values and corresponding quantity range attribute values for the item from the first provider of the item.

In example 2, the subject matter of example 1 can optionally include: determining that the desired attribute value for the item corresponds to a hidden attribute value; incrementing a commitment count for the quantity range attribute corresponding to the hidden attribute value; determining that the commitment count is within the quantity range attribute corresponding to the hidden attribute value, wherein the fulfillment request identifies the hidden attribute value and the commitment count for the item listed with the first provider.

In example 3, the subject matter of example 2 can optionally include: generating a confirmation of the fulfillment request to the first client device, the confirmation identifying the hidden attribute value and the commitment count for the item listed with the first provider.

In example 4, the subject matter of example 1 can optionally include: reiterating the detecting, querying, receiving, and generating for a second client device for a predefined time duration from the querying of the first client device.

In example 5, the subject matter of example 1 can optionally include: wherein detecting further comprises: receiving, within an elapsed time from receiving a request from the first client device to display the listing, a request from the first client device to display another listing provided by the publication application; and determining that the elapsed time exceeds a predefined duration threshold.

In example 6, the subject matter of example 1 can optionally include: wherein the commitment comprises a confirmation of a monetary deposit of a value corresponding to a portion of the disclosed attribute value.

In example 7, the subject matter of example 1 can optionally include: receiving a second desired attribute value and a commitment to the second desired attribute value from a second client device; and generating the fulfillment request based on the number of commitments and corresponding desired attribute values from the first client device and the second client device.

In example 8, the subject matter of example 1 can optionally include: accessing a database of hidden attribute values for the item and corresponding quantity range attribute values for the item listed with a second provider of the item, the hidden attribute values and corresponding quantity range attribute values provided by the second provider and hidden from the first client device; and generating the fulfillment request to a combination of the first provider and the second provider, based on the hidden attribute values and corresponding quantity range attribute values for the first provider and the second provider.

In example 9, the subject matter of example 8 can optionally include: ranking the first provider and the second provider based on rating parameters of each provider; and generating the fulfillment request to the first provider and the second provider based on the rating parameters and the number of commitments.

In example 10, the subject matter of example 1 can optionally include: wherein the desired attribute value includes a range of desired values, wherein generating the fulfillment request further comprises: incrementing a commitment count corresponding to a hidden attribute value for each value in the range of desired values.

What is claimed is:

1. A method comprising:
detecting, at a server, that an application operating at a first client device of a first user is leaving a display of a listing provided by a publication application, the listing identifying an item and a corresponding disclosed attribute value provided by a first provider of the item;
querying the first client device for a desired attribute value in response to the detecting;
receiving the desired attribute value and a commitment to the desired attribute value from the first client device;
accessing a database of hidden attribute values for the item and corresponding quantity range attribute values for the item listed with the first provider, the hidden attribute values and corresponding quantity range attribute values provided by the first provider and hidden from the first client device; and
generating a fulfillment request to the first provider based on a number of commitments and corresponding desired attribute values from the first client device, hidden attribute values and corresponding quantity range attribute values for the item from the first provider of the item.

2. The method of claim 1, further comprising:
determining that the desired attribute value for the item corresponds to a hidden attribute value;
incrementing a commitment count for the quantity range attribute corresponding to the hidden attribute value;
determining that the commitment count is within the quantity range attribute corresponding to the hidden attribute value,
wherein the fulfillment request identifies the hidden attribute value and the commitment count for the item listed with the first provider.

3. The method of claim 2, further comprising:
generating a confirmation of the fulfillment request to the first client device, the confirmation identifying the hidden attribute value and the commitment count for the item listed with the first provider.

4. The method of claim 1, further comprising: reiterating the detecting, querying, receiving, and generating for a second client device for a predefined time duration from the querying of the first client device.

5. The method of claim 1, wherein detecting further comprises:
receiving, within an elapsed time from receiving a request from the first client device to display the listing, a request from the first client device to display another listing provided by the publication application; and
determining that the elapsed time exceeds a predefined duration threshold.

6. The method of claim 1, wherein the commitment comprises a confirmation of a monetary deposit of a value corresponding to a portion of the disclosed attribute value.

7. The method of claim 1, further comprising:
receiving a second desired attribute value and a commitment to the second desired attribute value from a second client device; and
generating the fulfillment request based on the number of commitments and corresponding desired attribute values from the first client device and the second client device.

8. The method of claim 1,
accessing a database of hidden attribute values for the item and corresponding quantity range attribute values for the item listed with a second provider of the item, the hidden attribute values and corresponding quantity range attribute values provided by the second provider and hidden from the first client device; and
generating the fulfillment request to a combination of the first provider and the second provider, based on the hidden attribute values and corresponding quantity range attribute values for the first provider and the second provider.

9. The method of claim 8,
ranking the first provider and the second provider based on rating parameters of each provider; and
generating the fulfillment request to the first provider and the second provider based on the rating parameters and the number of commitments.

10. The method of claim 1, wherein the desired attribute value includes a range of desired values,
wherein generating the fulfillment request further comprises:
incrementing a commitment count corresponding to a hidden attribute value for each value in the range of desired values.

11. A computing apparatus, the computing apparatus comprising:
a processor; and
a memory storing instructions that, when executed by the processor, configure the apparatus to:
detect, at a server, that an application operating at a first client device of a first user is leaving a display of a listing provided by a publication application, the listing identifying an item and a corresponding disclosed attribute value provided by a first provider of the item;
query the first client device for a desired attribute value in response to the detecting;
receive the desired attribute value and a commitment to the desired attribute value from the first client device;
access a database of hidden attribute values for the item and corresponding quantity range attribute values for the item listed with the first provider, the hidden attribute values and corresponding quantity range attribute values provided by the first provider and hidden from the first client device; and
generate a fulfillment request to the first provider based on a number of commitments and corresponding desired attribute values from the first client device, hidden attribute values and corresponding quantity range attribute values for the item from the first provider of the item.

12. The computing apparatus of claim 11, wherein the instructions further configure the apparatus to:
determine that the desired attribute value for the item corresponds to a hidden attribute value;
incrementing a commitment count for the quantity range attribute corresponding to the hidden attribute value;
determine that the commitment count is within the quantity range attribute corresponding to the hidden attribute value,
wherein the fulfillment request identifies the hidden attribute value and the commitment count for the item listed with the first provider.

13. The computing apparatus of claim 12, wherein the instructions further configure the apparatus to:
generate a confirmation of the fulfillment request to the first client device, the confirmation identifying the hidden attribute value and the commitment count for the item listed with the first provider.

14. The computing apparatus of claim 11, reiterate the detecting, querying, receiving, and generating for a second client device for a predefined time duration from the querying of the first client device.

15. The computing apparatus of claim 11, wherein detecting further comprises:
receive, within an elapsed time from receiving a request from the first client device to display the listing, a request from the first client device to display another listing provided by the publication application; and
determine that the elapsed time exceeds a predefined duration threshold.

16. The computing apparatus of claim 11, wherein the commitment comprises a confirmation of a monetary deposit of a value corresponding to a portion of the disclosed attribute value.

17. The computing apparatus of claim 11, wherein the instructions further configure the apparatus to:
receive a second desired attribute value and a commitment to the second desired attribute value from a second client device; and
generate the fulfillment request based on the number of commitments and corresponding desired attribute values from the first client device and the second client device.

18. The computing apparatus of claim 11,
access a database of hidden attribute values for the item and corresponding quantity range attribute values for the item listed with a second provider of the item, the hidden attribute values and corresponding quantity range attribute values provided by the second provider and hidden from the first client device; and
generate the fulfillment request to a combination of the first provider and the second provider, based on the hidden attribute values and corresponding quantity range attribute values for the first provider and the second provider.

19. The computing apparatus of claim 18,
rank the first provider and the second provider based on rating parameters of each provider; and
generate the fulfillment request to the first provider and the second provider based on the rating parameters and the number of commitments.

20. A non-transitory computer-readable storage medium, the computer-readable storage medium including instructions that when executed by a computer, cause the computer to:
detect, at a server, that an application operating at a first client device of a first user is leaving a display of a listing provided by a publication application, the listing identifying an item and a corresponding disclosed attribute value provided by a first provider of the item;
query the first client device for a desired attribute value in response to the detecting;
receive the desired attribute value and a commitment to the desired attribute value from the first client device;
access a database of hidden attribute values for the item and corresponding quantity range attribute values for the item listed with the first provider, the hidden attribute values and corresponding quantity range attribute values provided by the first provider and hidden from the first client device; and
generate a fulfillment request to the first provider based on a number of commitments and corresponding desired attribute values from the first client device, hidden attribute values and corresponding quantity range attribute values for the item from the first provider of the item.
